(19) United States
(12) Patent Application Publication
(10) Pub. No.: US 2026/0111318 A1
(43) Pub. Date: Apr. 23, 2026

(54) METHOD, DEVICE, AND PROGRAM PRODUCT FOR ADJUSTING RECOVERY POINT OBJECTIVE

(71) Applicant: Dell Products L.P., Round Rock, TX (US)

(72) Inventors: Jie Huang, Chengdu (CN); Guoping Guan, Chengdu (CN); Xingxin Li, Chengdu (CN)

(21) Appl. No.: 19/194,877

(22) Filed: Apr. 30, 2025

(30) Foreign Application Priority Data
Oct. 23, 2024 (CN) 202411488469.4

(51) Int. Cl. G06F 11/14

(52) U.S. Cl. CPC G06F 11/1464

(57) ABSTRACT

Techniques for adjusting a recovery point objective involve determining a total replication bandwidth and a replication link bandwidth. The total replication bandwidth indicates the sum of replication bandwidths of a plurality of replication sessions, and the replication link bandwidth indicates a maximum bandwidth of a replication link. Such techniques further involve increasing a recovery point objective of the replication link in response to the total replication bandwidth being greater than the replication link bandwidth. The recovery point objective indicates a maximum data loss time range. Such techniques further involve reducing the recovery point objective of the replication link in response to the total replication bandwidth being less than the replication link bandwidth.

### CROSS-REFERENCE TO RELATED APPLICATION

This application claims priority to Chinese Patent Application No. CN202411488469.4, on file at the China National Intellectual Property Administration (CNIPA), having a filing date of Oct. 23, 2024, and having “METHOD, DEVICE AND PRODUCT FOR ADJUSTING RECOVERY POINT OBJECT” as a title, the contents and teachings of which are herein incorporated by reference in their entirety.

### TECHNICAL FIELD

The present disclosure relates generally to the field of computers, and more particularly, relates to a method, an electronic device, and a program product for adjusting a recovery point objective.

### BACKGROUND

Recovery point objective (RPO) is a key metric set in disaster recovery and business continuity plans, it defines the maximum amount of data loss a user can tolerate in recovering data from a recent valid back-up after a catastrophic event such as data loss or system crash, i.e., a time window in which the user can tolerate data loss. Bandwidth in digital devices refers to the amount of data that is transmitted through a link in unit time, usually expressed in bps (bits per second). It describes the theoretical maximum rate at which a network or line can transmit data.

In disaster recovery scenarios, bandwidth and recovery point objective jointly affect the speed and quality of data recovery. When a disaster occurs, if the bandwidth of back-up data is large enough, the data can be transmitted faster, thereby shortening the recovery time, reducing the amount of data loss, and making it closer to meeting the requirements of the recovery point objective.

### SUMMARY OF THE INVENTION

Embodiments of the present disclosure provide a method, a device, and a computer program product for adjusting a recovery point objective.

In a first aspect of the embodiments of the present disclosure, a method for adjusting a recovery point objective is provided. The method includes determining a total replication bandwidth and a replication link bandwidth, wherein the total replication bandwidth indicates the sum of replication bandwidths of a plurality of replication sessions, and the replication link bandwidth indicates a maximum bandwidth of a replication link. The method further includes increasing a recovery point objective of the replication link in response to the total replication bandwidth being greater than the replication link bandwidth, wherein the recovery point objective indicates a maximum data loss time range. The method further includes reducing the recovery point objective of the replication link in response to the total replication bandwidth being less than the replication link bandwidth.

In a second aspect of the embodiments of the present disclosure, an electronic device is provided. The electronic device includes one or more processors; and a storage apparatus configured to store one or more programs that, when executed by the one or more processors, cause the one or more processors to implement a method for adjusting a recovery point objective, the method including determining a total replication bandwidth and a replication link bandwidth, wherein the total replication bandwidth indicates the sum of replication bandwidths of a plurality of replication sessions, and the replication link bandwidth indicates a maximum bandwidth of a replication link. The method further includes increasing a recovery point objective of the replication link in response to the total replication bandwidth being greater than the replication link bandwidth, wherein the recovery point objective indicates a maximum data loss time range. The method further includes reducing the recovery point objective of the replication link in response to the total replication bandwidth being less than the replication link bandwidth.

In a third aspect of the embodiments of the present disclosure, a computer-readable storage medium is provided, on which a computer program is stored, wherein the program, when executed by a processor, implements a method for adjusting a recovery point objective, the method including determining a total replication bandwidth and a replication link bandwidth, wherein the total replication bandwidth indicates the sum of replication bandwidths of a plurality of replication sessions, and the replication link bandwidth indicates a maximum bandwidth of a replication link. The method further includes increasing a recovery point objective of the replication link in response to the total replication bandwidth being greater than the replication link bandwidth, wherein the recovery point objective indicates a maximum data loss time range. The method further includes reducing the recovery point objective of the replication link in response to the total replication bandwidth being less than the replication link bandwidth.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above-mentioned and other features, advantages, and aspects of the embodiments of the present disclosure will become more apparent with reference to the accompanying drawings and the following detailed description. In the drawings, identical or similar reference numerals represent identical or similar elements, in which:

FIG. 1 illustrates a schematic diagram of an example environment in which a plurality of embodiments of the present disclosure can be implemented;

FIG. 2 illustrates a flow chart of a method for adjusting a recovery point objective according to some embodiments of the present disclosure;

FIG. 3 illustrates a schematic diagram of an overall process of adjusting a recovery point objective according to some embodiments of the present disclosure;

FIG. 4 illustrates a schematic diagram of initial states of some replication sessions in a replication round according to some embodiments of the present disclosure;

FIG. 5 illustrates a schematic diagram of a process of increasing a recovery point objective according to some embodiments of the present disclosure;

FIG. 6 illustrates a schematic diagram of a replication cycle in which recovery point objectives of some replication sessions are increased according to some embodiments of the present disclosure;

FIG. 7 illustrates a schematic diagram of a process of reducing a recovery point objective according to some embodiments of the present disclosure;

FIG. 8 illustrates a schematic diagram of a replication cycle in which recovery point objectives of some replication sessions are reduced according to some embodiments of the present disclosure;

FIGS. 9A-9F illustrate schematic diagrams of example effects where the total replication bandwidth is greater than the replication link bandwidth according to some embodiments of the present disclosure;

FIGS. 10A-10F illustrate schematic diagrams of example effects where the total replication bandwidth is less than the replication link bandwidth according to some embodiments of the present disclosure;

FIGS. 11A-11F illustrate schematic diagrams of example effects where the total replication bandwidth is equal to the replication link bandwidth according to some embodiments of the present disclosure; and

FIG. 12 illustrates a block diagram of a device that may implement a plurality of embodiments of the present disclosure.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may further be included below.

As mentioned above, bandwidth and recovery point objective jointly affect the speed and quality of data recovery. Some technologies already can support a limited number of recovery point objective options, such as being fixed at 5 minutes. However, this only supports setting a limited number of recovery point objectives with fixed units, and cannot support more flexibly setting recovery point objectives to protect users' disaster recovery data in the case of limited resources. Moreover, in related arts, users need to manually set and adjust recovery point objectives, which consumes users' time and effort. Additionally, in such method of manually setting recovery point objectives, it is difficult to properly set recovery point objectives while ensuring data consistency (e.g., setting recovery point objectives too long or too short), resulting in reduced utilization of replication link's bandwidth or the possibility of missing a predetermined recovery point objective, thereby impacting the protection for disaster data of users. In addition, in related arts, an adjustment to a recovery point objective does not take into account data changes of a source object.

To this end, embodiments of the present disclosure provide a solution for adjusting a recovery point objective. In the embodiments of the present disclosure, a recovery point objective is adjusted in real time by comparing a total replication bandwidth of replication sessions to be completed with a replication link bandwidth, and if the total replication bandwidth is greater than the replication link bandwidth, the recovery point objective is increased to reduce the total replication bandwidth. Conversely, if the total replication bandwidth is less than the replication link bandwidth, the recovery point objective is reduced to increase the total replication bandwidth. In this way, the recovery point objective can be dynamically adjusted in real time according to the total bandwidth of the replication sessions, which not only avoids the trouble of manual setting by users, but also can effectively utilize bandwidth resources of the replication link, improve the replication efficiency, and also strengthen data protection, thereby improving the user experience.

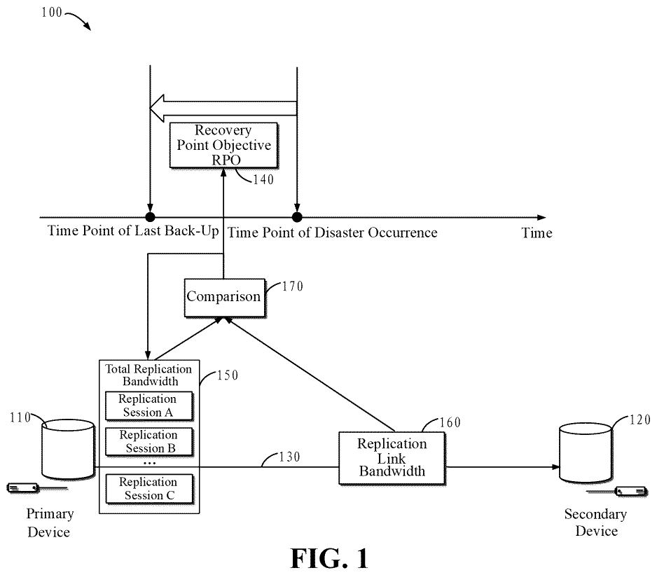

FIG. 1 illustrates a schematic diagram of an example environment 100 in which a plurality of embodiments of the present disclosure can be implemented. As shown in FIG. 1, in order to ensure the integrity and availability of business data, the data can be backed up (or replicated) periodically or in real time from a primary device 110 to a secondary device 120 via a replication link 130. In order to ensure the quality and efficiency of this replication operation and to meet the business's tolerance for data loss during disaster recovery, an appropriate recovery point objective RPO 140 can be set. The recovery point objective RPO 140 refers to the maximum amount of data loss that the business can tolerate when a disaster occurs. It defines the point in time for data recovery, that is, the point in time at which the data state of the business can be recovered after a disaster occurs, typically in units of time. For ease of description, RPO and recovery point objective can refer to each other below. If the recovery point objective is set to 5 minutes, it means that at most the loss of data from the past 5 minutes can be tolerated during disaster recovery.

The setting of the recovery point objective directly affects the frequency and policy of data replication. When a user sets a recovery point objective, in order to meet the requirements of the recovery point objective, there is a need to ensure that data can be properly replicated from the primary device 110 to the secondary device 120 so that data loss can be minimized in the event of a disaster. For example, if the recovery point objective is set to a short period of time (e.g., in units of minutes), more frequent data replication is required to ensure that data on the secondary device 120 is synchronized with data on the primary device 110. If the recovery point objective is set to a long period of time (e.g., in units of hours), the frequency and resource consumption of data replication can be reduced, but it may also have a negative impact on business continuity. In the event of a disaster, if the data on the secondary device 120 is too different from the data on the primary device 110, the recovery time of the business will be prolonged, thereby affecting the normal operation of the business and the customer satisfaction.

Referring to FIG. 1, for each asynchronous replication session (replication session A, replication session B, replication session C, etc. as shown in FIG. 1), when a new replication cycle begins, differential data generated in the previous cycle will be replicated to a remote location, e.g., the secondary device 120. A plurality of replication sessions that are being synchronized or about to be synchronized share the same replication link 130, thus limiting a maximum replication bandwidth of all the replication sessions. In order to complete a user-defined recovery point objective and further optimize the efficiency of data storage and replication, a data replication bandwidth (which can also be understood as a replication speed) of each replication session can be adaptively adjusted within the range of the user-defined recovery point objective (e.g., the user can set a fluctuation range of the recovery point objective to [1,30] minutes), so that an adaptive adjustment to the RPO can be achieved according to the adjusted data replication bandwidth of each new replication session, and in this way, the efficient replication of data can be achieved without consuming the effort of users to set a reasonable RPO.

In some embodiments, a bandwidth (e.g., a total replication bandwidth 150 of a plurality of replication sessions A, replication sessions B, replication sessions C, etc.) required to complete data replication within a time frame specified in user-defined data protection can be calculated, and then compared with a replication link bandwidth 160 at 170 to dynamically adjust the RPO. The replication link bandwidth 160 refers to a maximum replication bandwidth of the current replication link 130, and the total replication bandwidth 150 refers to the sum of replication bandwidths required to replicate the replication link 130 shared by each replication session from the primary device 110 to the secondary device 120. Through such method of adaptively adjusting a RPO, the efficiency of data storage and replication can be optimized while resources are fully utilized, and the recovery point objective can also be satisfied.

In some embodiments, if the total replication bandwidth 150 is greater than the replication link bandwidth 160, then a user-defined recovery point objective cannot be achieved within a specified time range. At this point, in order to satisfy the user-defined recovery point objective, the total replication bandwidth 150 and the replication link bandwidth 160 can be equalized by reducing the replication bandwidths of some replication sessions, and at this point, the recovery point objective will be adaptively increased within the user-defined time range.

In some embodiments, if the total replication bandwidth 150 is less than the replication link bandwidth 160, it means that the replication link bandwidth 160 is not fully utilized within a specified time range. At this point, in order to optimize the efficiency of storage and replication, the total replication bandwidth 150 and the replication link bandwidth 160 can be equalized by increasing the replication bandwidths of the replication sessions, and at this point, the recovery point objective will be adaptively reduced within the user-defined time range.

In this way, the recovery point objective can be dynamically adjusted in real time according to the total bandwidth of the replication sessions, which not only avoids the trouble of manual setting by users, but also can effectively utilize bandwidth resources of the replication link, improve the replication efficiency, and also strengthen data protection, thereby improving the user experience.

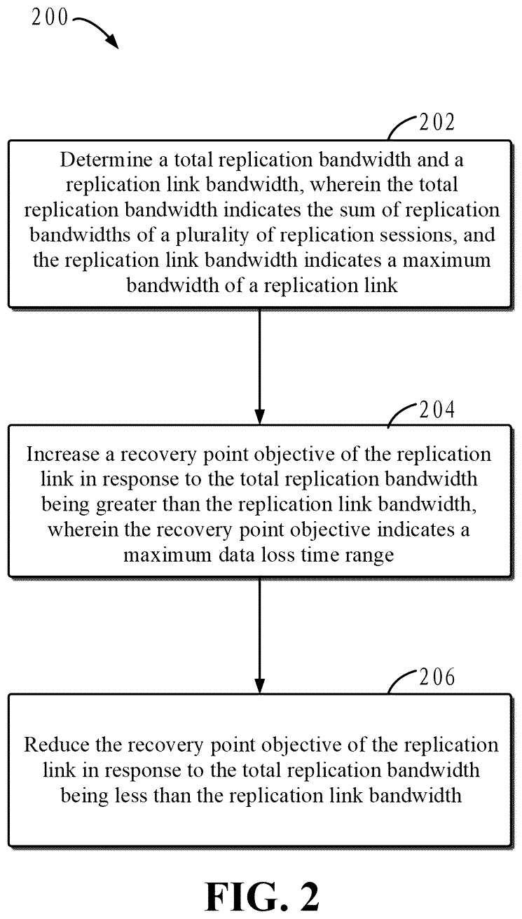

FIG. 2 illustrates a flow chart of a method 200 for adjusting a recovery point objective according to some embodiments of the present disclosure. Referring to FIG. 2, the method 200 includes a block 202, a block 204, and a block 206. An execution subject of the method 200 may be an apparatus for adjusting a recovery point objective.

At the block 202, a total replication bandwidth and a replication link bandwidth are determined, where the total replication bandwidth indicates the sum of replication bandwidths of a plurality of replication sessions, and the replication link bandwidth indicates a maximum bandwidth of a replication link. Referring to FIG. 1, for each asynchronous replication session (replication session A, replication session B, replication session C, etc. as shown in FIG. 1), when a new replication cycle begins, differential data generated in the previous cycle will be replicated to a remote location, e.g., the secondary device 120. A plurality of replication sessions that are being synchronized or about to be synchronized share the same replication link 130, thus limiting a maximum replication bandwidth of all the replication sessions. In order to complete a user-defined recovery point objective and further optimize the efficiency of data storage and replication, a data replication bandwidth (which also can be understood as a replication speed) of each replication session can be adaptively adjusted within the range of the user-defined RPO, so that an adaptive adjustment to the RPO can be achieved according to the adjusted data replication bandwidth of each new replication session. In some embodiments, a bandwidth (e.g., a total replication bandwidth 150 of a plurality of replication sessions A, replication sessions B, and replication sessions C) required to complete data replication within a time range specified in user-defined data protection can be calculated, and then compared with a replication link bandwidth 160 at 170 to dynamically adjust the RPO. The replication link bandwidth 160 refers to a maximum replication bandwidth of the current replication link 130, and the total replication bandwidth 150 refers to the sum of replication bandwidths required to replicate the replication link 130 shared by each replication session from the primary device 110 to the secondary device 120. Through such method of adaptively adjusting a RPO, the efficiency of data storage and replication can be optimized while resources are fully utilized, and the recovery point objective can also be satisfied.

At the block 204, a recovery point objective of the replication link is increased in response to the total replication bandwidth being greater than the replication link bandwidth, where the recovery point objective indicates a maximum data loss time range. Referring to FIG. 1, in some embodiments, if the total replication bandwidth 150 is greater than the replication link bandwidth 160, then a user-defined recovery point objective cannot be achieved within a specified time range. At this point, in order to satisfy the user-defined recovery point objective, the total replication bandwidth 150 and the replication link bandwidth 160 can be equalized by reducing the replication bandwidths of some replication sessions, and at this point, the recovery point objective will be adaptively increased within the user-defined time range.

At the block 206, the recovery point objective of the replication link is reduced in response to the total replication bandwidth being less than the replication link bandwidth. Referring to FIG. 1, in some embodiments, if the total replication bandwidth 150 is less than the replication link bandwidth 160, it means that the replication link bandwidth 160 is not fully utilized within a specified time range. At this point, in order to optimize the efficiency of storage and replication, the total replication bandwidth 150 and the replication link bandwidth 160 can be equalized by increasing the replication bandwidths of the replication sessions, and at this point, the recovery point objective will be adaptively reduced within the user-defined time range.

By means of the method for adaptively adjusting a recovery point objective, the recovery point objective can be dynamically adjusted in real time according to the total bandwidth of the replication sessions, which not only avoids the trouble of manual setting by users, but also can effectively utilize bandwidth resources of the replication link, improve the replication efficiency, and also strengthen data protection, thereby improving the user experience.

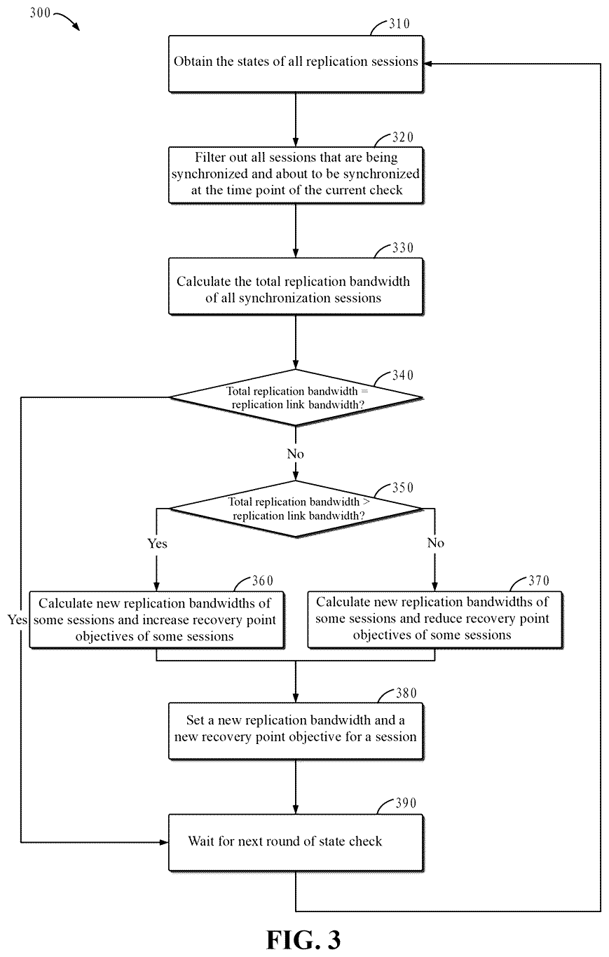

A process of adjusting a recovery point objective will be described below with reference to FIGS. 3-8. FIG. 3 illustrates a schematic diagram of an overall process 300 of adjusting a recovery point objective according to some embodiments of the present disclosure. Referring to FIG. 3, at the block 310, the states of all replication sessions are obtained. In this process, the state of each replication session can be learned, and the states of the replication sessions can be being synchronized, about to be synchronized, or already synchronized. After the states of all replication sessions are obtained, at the block 320, all replication sessions that are being synchronized and that are about to be synchronized can be filtered out at the time point of the current check (e.g., a check interval is 5 seconds). In some embodiments, after the replication sessions are filtered out, the filtered replication sessions may be ranked. Synchronization means replicating data from one device to another. It is understood that replication session and session below may refer to each other, and replication cycle and replication round may also refer to each other.

In some embodiments, the filtered replication sessions may be ranked according to a comprehensive score for the replication sessions, i.e., the replication sessions need to be ranked each time it is determined whether to adjust a replication session. In some embodiments, the comprehensive score is the product of a first score, a second score, and a third score. In some embodiments, for the first score, all sessions that are being synchronized or that are about to be synchronized may be ranked from low to high based on a total amount of differential data for a current replication cycle. The sessions with the same amount of differential data will have the same rank. Then, the first score is calculated, as shown in Formula (1):

$${score}_{1} = log ( {rank}_{i} ) + 1 , i = 1 , 2 , 3 , … N \qquad ( 1 )$$

where rankᵢ is the rank of each replication session.

In some embodiments, the second score may be determined according to a user-defined priority of business data, as shown in Formula (2):

$${score}_{2} = \{ \begin{matrix}1 , if user\_defined \_priority = low \\ 2 , if user\_defined \_priority = medium \\ 3 , if user\_defined \_priority = high\end{matrix} \qquad ( 2 )$$

where the highest priority is 3, the lowest priority is 1, and the medium priority is 2.

In some embodiments, the third score may be determined according to the total host I/O amount of each replication session, the total host I/O amounts are ranked from low to high, and replication sessions whose total host I/O amounts are the same will have the same rank. As shown in Formula (3):

$${score}_{3} = log ( {rank}_{i} ) + 1 , i = 1 , 2 , 3 , … N \qquad ( 3 )$$

Still referring to FIG. 3, when all replication sessions that are being synchronized or about to be synchronized are obtained, a total replication bandwidth of the filtered replication sessions may be calculated at the block 330. For each asynchronous replication session, when a new replication cycle begins, differential data generated in the previous cycle will be replicated to a remote location. All sessions that are being synchronized or about to be synchronized share the same replication link. It is understood that, ideally, the sum of replication bandwidths of all the sessions should be less than or equal to the replication link bandwidth. As shown in Formula (4):

$$Total\_Replication \_BW = {\sum }_{i = 1}^{N} {Replication\_BW}_{i} \leq Replication\_link \_BW \qquad ( 4 )$$

where Total_Replication_BW is the sum of replication bandwidths of all replication sessions. Replication_BWᵢ is the replication bandwidth of the i-th replication session. Replication_link_BW is a maximum replication bandwidth of the replication link (it is assumed that there is only one replication link from the primary device to the secondary device). N is the number of the replication sessions.

In some embodiments, the product of the replication bandwidth and the replication duration of each replication session is the amount of data that needs to be replicated for each replication session. As shown in Formula (5):

$$Data\_to {\_Replicate}_{i} = {Replication\_BW}_{i} \times {Replication\_Duration}_{i} \qquad ( 5 )$$

where Data_to_Replicateᵢ is the amount of data that needs to be replicated for each replication session at the beginning of the replication cycle, and Replication_Durationᵢ is the replication duration required for each replication session to complete the replication task.

In some embodiments, when a replication round starts, the replication bandwidth of each replication session can be calculated according to Formula (6) as follows:

$${Replication\_ BW}_{i} = \frac{Data\_to {\_Replicate}_{i}}{{RPO}_{i}} \qquad ( 6 )$$

where RPOᵢ is the recovery point objective of each replication session.

In some embodiments, after the replication round starts, the replication bandwidth of each replication session can be calculated according to Formula (7) as follows:

$${Replication\_ BW}_{i} = \frac{Left\_Data {\_Replicate}_{i}}{Left\_Sync {\_Time}_{i}} \qquad ( 7 )$$

where Left_Data_Replicateᵢ is data that has not yet been replicated to the secondary device, and Left_Sync_Timeᵢ is the remaining duration to complete the current replication cycle without triggering a recovery point objective alert.

In some embodiments, the total replication bandwidth of all replication sessions may be expressed as the following formula:

$$Total\_Replication \_ BW = {\sum }_{i = 1}^{N} {Replication\_ BW}_{i} = {\sum }_{i = 1}^{N} \frac{Left\_Data {\_Replicate}_{i}}{Left\_Sync {\_Time}_{i}} \qquad ( 8 )$$

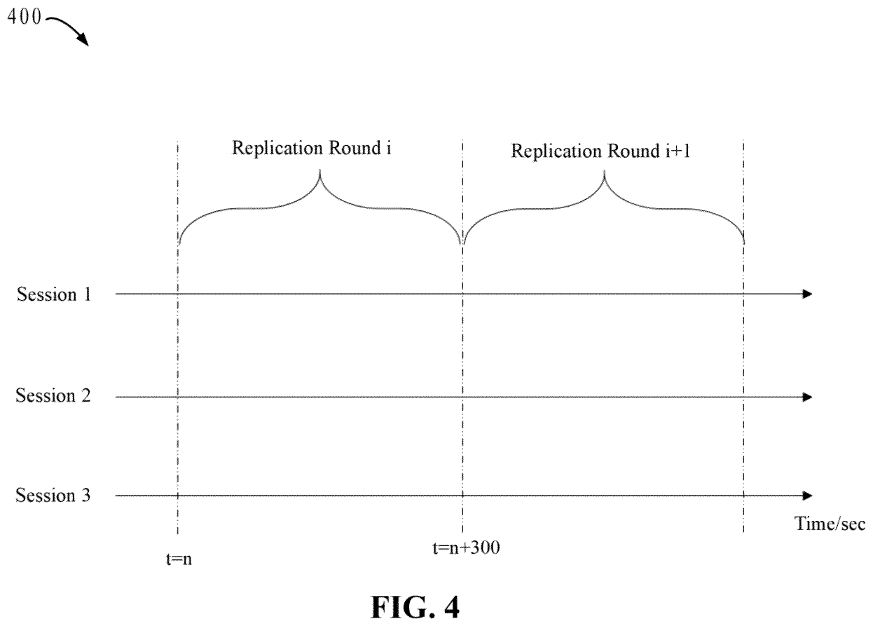

The description will be made below with reference to FIG. 4. FIG. 4 illustrates a schematic diagram of initial states 400 of some replication sessions in a replication round according to some embodiments of the present disclosure. Referring to FIG. 4, in a replication roundi, the number of the replication sessions is 3, i.e., session 1, session 2, and session 3. It is assumed that an initial recovery point objective is 5 minutes, a user-set range of the recovery point objective is [1,30] minutes, the unit of each recovery point objective increment is 1 minute, the check interval is 5 seconds, and a maximum bandwidth of the replication link is 30 MBps.

As shown in FIG. 4, all the replication sessions (i.e., session 1, session 2, and session 3) will start the i-th replication cycle at the same time point t=n, and the next replication cycle will start from t=n+300. In the i-th replication cycle, differential data generated in the previous cycle (that is, the i−1-th replication cycle) will be synchronized to the secondary device. It is assumed that the differential data of each replication session in the previous cycle of the i-th replication cycle is shown in Table 1:

TABLE 1

| Session | Differential data generated in the previous cycle |
|---|---|
| Session 1 | 4800 MB |
| Session 2 | 2700 MB |
| Session 3 | 3000 MB |

Based on Table 1 and the data assumed above, the remaining synced data, remaining sync time, and current recovery point objective of session 1, session 2, and session 3 at the beginning of the replication cycle can be calculated, respectively, as shown in Table 2:

TABLE 2

| | Remaining synced | Remaining sync | |
|---|---|---|---|
| Session | data/MB | time/sec | Current RPO/min |
| Session 1 | 4800 | 300 | 5 |
| Session 1 | 2700 | 300 | 5 |
| Session 3 | 3000 | 300 | 5 |

Then, according to Formula (7) or (8), the replication bandwidth requirement of each replication session without missing a recovery point objective can be calculated, as shown in Table 3:

TABLE 3

| Session | Replication Bandwidth/(MB/s) |
|---|---|
| Session 1 | 16 |
| Session 2 | 9 |
| Session 3 | 10 |

According to Formula (8), the total replication bandwidth of the replication sessions can be calculated as 35 MBps.

Still referring to FIG. 3, at the block 340, it is determined whether the total replication bandwidth is equal to the replication link bandwidth, this is because if the total replication bandwidth can be equal to the maximum replication bandwidth, then the resource utilization is theoretically the highest. In conjunction with Table 3, the total replication bandwidth is 35 MBps, which is not equal to 30 MBps. If the determination at 340 is no, it can be determined at 350 whether the total replication bandwidth is greater than the replication link bandwidth. If the determination at 350 is yes, new replication bandwidths of some sessions may be calculated and recovery point objectives of some replication sessions may be increased at 360. If the determination at 350 is no, new replication bandwidths of some sessions may be calculated and recovery point objectives of some replication sessions may be reduced at 370. In conjunction with Table 3, the total replication bandwidth is 35 Mbps, which is greater than 30 MBps, then the operation will continue at 360.

In some embodiments, in a process of increasing the recovery point objective of each replication session, an attempt may be first made to increase the recovery point objectives of the replication sessions whose recovery point objectives have previously been reduced; if the purpose of reducing the total replication bandwidth still cannot be achieved after the recovery point objectives of the replication sessions whose recovery point objectives have been reduced are increased to an initial recovery point objective, then an attempt may be made to continue to increase the recovery point objectives of the replication sessions whose recovery point objectives are already greater than or equal to the initial recovery point objective until the recovery point objectives of the replication sessions are increased to a user-defined maximum recovery point objective, and if the requirement that the total replication bandwidth is less than the replication link bandwidth still cannot be satisfied, the recovery point objectives of the replication sessions need not to be increased; instead, the remaining replication durations of the replication sessions can be increased proportionally, and in such a way, the user-defined recovery point objective can be achieved while the replication link bandwidth can be fully utilized.

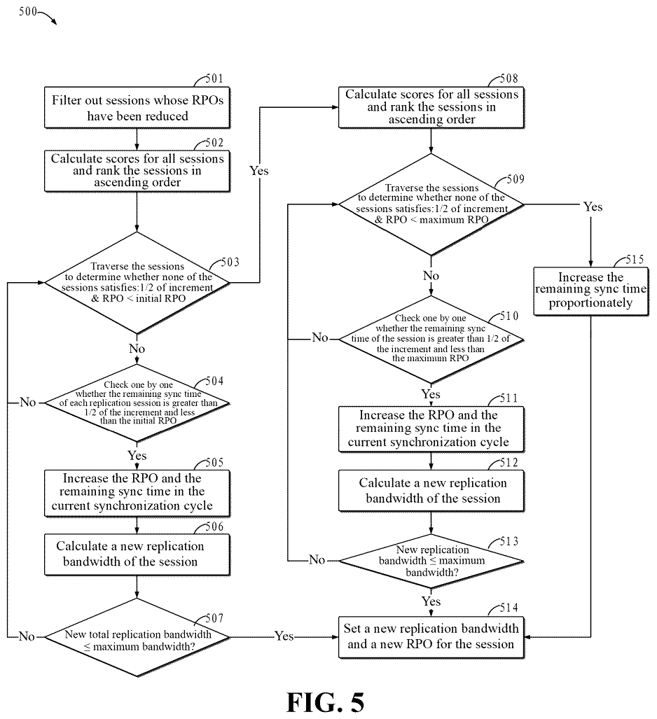

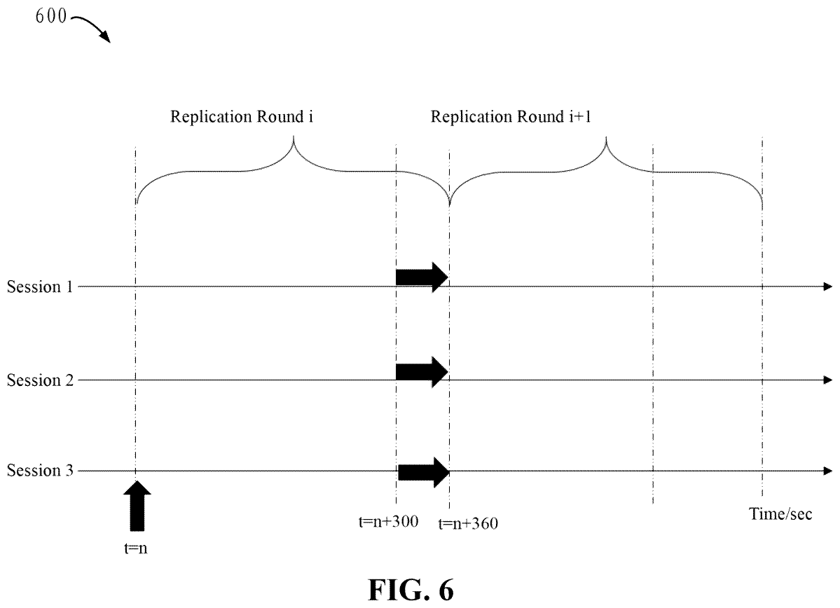

In some embodiments, each time the determination is made as to whether the recovery point objective needs to be increased, the remaining replication duration and new replication bandwidth of each replication session and whether the condition for increasing the recovery point objective is satisfied need to be calculated, and the replication sessions need to be ranked. The description will be made below with reference to FIGS. 5-6. FIG. 5 illustrates a schematic diagram of a process 500 of increasing a recovery point objective according to some embodiments of the present disclosure.

Referring to FIG. 5, as mentioned above, at the block 501, replication sessions whose recovery point objectives have been reduced may be filtered out first, and this is because when the total replication bandwidth is greater than the replication link bandwidth, the replication bandwidths of some replication sessions need to be reduced. And if the replication bandwidths of some replication sessions need to be reduced, it is possible to increase their time to replicate remaining data according to the logic of Formulas (5), (6), or (7), and at the same time, increase their recovery point objectives.

Therefore, referring to FIG. 5, it is possible at 501 to first filter out the replication sessions whose recovery point objectives have been reduced, i.e., the sessions whose recovery point objectives are already less than the initial recovery point objective, and gradually increase the recovery point objectives of the replication sessions whose recovery point objectives have been reduced to the initial recovery point objective. In conjunction with Table 2, the recovery point objectives of session 1, session 2, and session 3 have not been reduced and are not less than the Initial recovery point objective. Therefore, next, an attempt can be next made to increase the recovery point objectives of the replication sessions whose recovery point objectives are greater than or equal to the initial recovery point objective. In the process of increasing the recovery point objectives of the replication sessions whose recovery point objectives are greater than or equal to the initial recovery point objective, a new remaining duration of each replication session needs to be calculated. After the new remaining duration of each replication session is calculated, whether the recovery point objective of each replication session needs to be really increased needs to be further determined according to the remaining replication duration of the current replication cycle or replication round. This is because if some replication sessions are about to be completed soon in the current cycle, there is no need to continue to reduce its replication bandwidth to lengthen its remaining replication duration. Such adjustment is not worth the candle.

In conjunction with Table 2, the recovery point objectives of session 1, session 2, and session 3 are equal to the initial recovery point objective. Therefore, an attempt can be made to increase the recovery point objectives of session 1, session 2, and session 3 whose recovery point objectives are greater than or equal to the initial recovery point objective. Still referring to FIG. 5, scores can be calculated for all replication sessions according to Formulas (1), (2), and (3) and ranked in ascending order at the block 502. In conjunction with Formulas (1)-(3) and Tables 1-3, the scores for session 1, session 2, and session 3 can be calculated as shown in Table 4:

TABLE 4

| | First | Second | Third | Comprehensive | Ranking in |
|---|---|---|---|---|---|
| | score | score | score | score | ascending order |
| Session 1 | 2.1 | 1 | 3 | 6.3 | 3 |
| Session 2 | 1 | 1 | 1 | 1 | 1 |
| Session 3 | 1.7 | 1 | 2 | 3.4 | 2 |

Still referring to FIG. 5, at the block 503, the sessions may be traversed to observe the states of the sessions. That is, it is determined whether none of the replication sessions satisfies that: whether half of an increment of each replication session is less than the initial recovery point objective and whether the recovery point objectives of the replication sessions are less than the initial recovery point objective. In conjunction with Table 1, Table 2, and Table 3, Session 1, Session 2, and Session 3 do not satisfy the conditions.

If the replication sessions do not satisfy the determination conditions at 503, the sessions may be checked one by one at 504, and it may be determined whether the remaining sync times of the replication sessions are greater than half of the increment and less than the initial recovery point objective. If the determination at 504 is no, the process returns to 503 to continue the determination.

If the determination at 503 is yes, scores for all sessions may be calculated and ranked in ascending order at 508. Then, it may be determined at 509 whether none of the replication session satisfies: half of the increment of the session is less than or equal to a maximum recovery point objective and the current recovery point objective of the replication session is less than the maximum recovery point objective. This determination here at 509 is to confirm whether the total replication bandwidth still does not satisfy the condition of being less than or equal to the replication link bandwidth after the recovery point objectives of all the replication sessions are increased to a user-set maximum recovery point objective. If the determination at 509 is yes, it means that the condition that the total replication bandwidth is less than the replication link bandwidth still cannot be achieved after the recovery point objectives of all the replication sessions are increased to the maximum recovery point objective, then the remaining durations of all the replication sessions can be increased proportionately at 515 without increasing the recovery point objectives of the replication sessions. A formula for increasing the remaining replication durations of all replication sessions is as follows:

$$New\_Left \_Sync {\_Time}_{ij} = Left\_Sync {\_Time}_{ij} * \frac{Total\_Replication {\_BW}_{j}}{Replication\_Link \_BW} \qquad ( 9 )$$

If the determination at 509 is no, then whether the remaining sync time of each replication session is greater than half of an increment of its recovery point objective and less than the maximum recovery point objective needs to be checked one by one at 510. If the determination at 510 is yes, then the recovery point objectives and remaining sync times of the replication sessions in the current synchronization cycle may be increased at 511, and a new replication bandwidth of each replication session may be calculated at 512, so that it may be determined at 513 whether the current new total replication bandwidth is less than or equal to the maximum replication bandwidth.

If the determination at 513 is yes, then new replication bandwidths and new recovery point objectives may be set for the replication sessions at 514, and if the determination at 513 is no, then the determination at 509 may continue to be repeated.

Still referring to FIG. 5, if the determination at 504 is yes, the recovery point objectives and the remaining sync times in the current synchronization cycle may be increased at 505, and the new replication bandwidth of each replication session may be calculated at 506 according to the currently calculated remaining sync time. In some embodiments, Formula (10) may be referred to in the determination at 504 as follows:

$$New\_Left \_Sync {\_Time}_{ij} = \{ \begin{matrix}Left\_Sync {\_Time}_{ij} + \\ RPO\_Increment ifLeft \_Sync {\_Time}_{i} > \frac{RPO\_Increment}{2} \\ Left\_Sync {\_Time}_{ij} if Left\_Sync {\_Time}_{ij} \leq \frac{RPO\_Increment}{2}\end{matrix} \qquad ( 10 )$$

where RPO_Increment is a predetermined unit increment for each increment of the recovery point objective. This is because if some replication sessions are about to be completed soon in the current cycle, there is no need to continue to reduce their replication bandwidths to lengthen their remaining replication durations. Such adjustment is not worth the candle.

After a new replication bandwidth of each replication session is calculated, it may be determined at 507 whether a new total replication bandwidth is less than or equal to the maximum bandwidth of the replication link. If so, a new replication bandwidth and a new recovery point objective may be set at 514 for each replication session.

In conjunction with Tables 1-4, a process for adjusting and determining Session 1, Session 2, and Session 3 is shown in Table 5:

TABLE 5

| | | First-Round Adjustment | | |
|---|---|---|---|---|
| | | First | Second | Third |
| Session | Rank | Adjustment | adjustment | Adjustment |
| Session 1 | 3 | — | — | Remaining |
| | | | | replication |
| | | | | duration +1 |
| | | | | minute |
| Session 2 | 1 | Remaining | — | — |
| | | replication | | |
| | | duration +1 | | |
| | | minute | | |
| Session 3 | 2 | — | Remaining | — |
| | | | replication | |
| | | | duration +1 | |
| | | | minute | |
| Total | / | 16 + 2700/ | 16 + 2700/ | 4000/3600 + |
| Replication | | 360 + 10 = | 360 + 3000/ | 2700/360 + 3000/ |
| Bandwidth | | 33.5 > 30 | 360 = 31.9 > 30 | 360 = 29.3 < 30 |

The new remaining sync time, new recovery point objective, and new replication bandwidth of each adjusted replication session at the beginning of the replication round are shown in Table 6:

TABLE 6

| | Remaining | New | | |
|---|---|---|---|---|
| | replication | remaining | New | New replication |
| Session | data/MB | sync time/sec | RPO/min | bandwidth/(MB/s) |
| Session 1 | 4800 | 360 | 6 | 13.4 |
| Session 2 | 2700 | 360 | 6 | 7.5 |
| Session 3 | 3000 | 360 | 6 | 8.4 |

In some embodiments, a formula for adjusting the new recovery point objective is as follows:

$${New\_RPO}_{ij} = {RPO}_{ij} + RPO\_Increment \qquad ( 11 )$$

where RPOᵢⱼ is the recovery point objective of a replication session at a time point j, and New_RPOᵢⱼ is the new recovery point objective of the replication session at the time point j.

In conjunction with FIG. 6, FIG. 6 illustrates a schematic diagram of a replication cycle 600 in which recovery point objectives of some replication sessions are increased according to some embodiments of the present disclosure. After an adjustment is performed at a time point t=n, the recovery point objective of each session is increased to 360 seconds. Each replication session will complete the replication task of the i-th cycle at the time point t=n+360 while also achieving the recovery point objective. As can be seen from FIG. 6, the start time of the next cycle will be t=n+360.

Through the method for dynamically adjusting the recovery point objective, the replication link bandwidth can be utilized most efficiently, thereby improving the replication efficiency.

Returning to FIG. 3, after new replication sessions of some sessions are calculated and recovery point objectives of some sessions are increased at 360 and new replication bandwidths and new recovery points are set for the replication sessions at 380, it is possible to continue to wait at 390 for the next round of state check. Thus, the states of all replication sessions can be obtained again for the next round of adjustment. In some embodiments, the time interval for state checks can be set to 5 seconds.

In further conjunction with FIG. 4, in a replication roundi, the number of the replication sessions is 3, i.e., session 1, session 2, and session 3. It is assumed that the initial RPO is 5 minutes, a user-set range of the RPO is [1,30] minutes, the unit of increment of each RPO is 1 minute, the check interval is 5 seconds, and the maximum bandwidth of the replication link is 30 MBps. All the replication sessions (i.e., session 1, session 2, and session 3) will start the i-th replication cycle at the same time. For example, the start time is set to t=n, and the next replication cycle will start from t=n+300. In the i-th replication cycle, differential data generated in the previous cycle will be synchronized to the secondary device. It is assumed that the differential data of each replication session in the previous cycle of the i-th replication cycle is shown in Table 7:

TABLE 7

| Session | Differential data generated in the previous cycle |
|---|---|
| Session 1 | 1800 MB |
| Session 2 | 2700 MB |
| Session 3 | 1200 MB |

According to Table 7, the remaining synced data, remaining sync time, and current recovery point objective of session 1, session 2, and session 3 can be calculated, respectively, as shown in Table 8:

TABLE 8

| | Remaining synced | Remaining sync | |
|---|---|---|---|
| Session | data/MB | time/sec | Current RPO/min |
| Session 1 | 1800 | 300 | 5 |
| Session 1 | 2700 | 300 | 5 |
| Session 3 | 1200 | 300 | 5 |

According to Formula (7) or (8), the replication bandwidth of each replication session can be calculated as shown in Table 9:

TABLE 9

| Session | Replication Bandwidth/(MB/s) |
|---|---|
| Session 1 | 6 |
| Session 2 | 9 |
| Session 3 | 4 |

According to Formula (8), the total replication bandwidth of the replication sessions can be calculated as 19 MBps.

Referring back to FIG. 3, at 340, it is determined whether the total replication bandwidth is equal to the replication link bandwidth. In conjunction with Table 3, the total replication bandwidth is 19 MBps, which is not equal to 30 MBps. If the determination at 340 is no, it can be determined at 350 whether the total replication bandwidth is greater than the replication link bandwidth. If the determination at 350 is no, new replication bandwidths of some sessions may be calculated and recovery point objectives of some replication sessions may be reduced at 370. In conjunction with Table 9, the total replication bandwidth is 19 MBps, which is less than 30 MBps, and the operation of 370 will be continued below.

In some embodiments, in the process of reducing the recovery point objective of each replication session, an attempt may be first made to reduce the recovery point objectives of the replication sessions whose recovery point objectives are equal to the maximum recovery point objective and whose remaining replication duration in the next round is greater than the sum of the remaining replication duration and the consumed replication duration. Generally speaking, the recovery point objectives of the replication sessions whose recovery point objectives have been increased are filtered out, and the remaining replication duration of the replication session needs also to be considered here. Here, for the filtered replication sessions, their replication bandwidths are increased so that the total replication bandwidth and the replication link bandwidth tend to be equal, which can reduce the remaining replication duration.

In some embodiments, if the remaining replication duration of each replication plan whose remaining replication duration has been reduced has been reduced to a difference between the recovery point objective of each replication session and the time already consumed by each replication session and at this time the total replication bandwidth is still less than the replication link bandwidth, then the replication sessions whose recovery point objectives are greater than the initial recovery point objective and less than the maximum recovery point objective can be filtered out from a plurality of replication sessions, and the remaining replication durations of the replication sessions can be reduced, and if their recovery point objectives have been reduced to the initial recovery point at this point but the total replication bandwidth still does not reach the same bandwidth as the replication link bandwidth, then the remaining replication durations of the replication sessions whose recovery point objectives are less than the initial recovery point objective can be reduced.

In some embodiments, in the process of reducing the recovery point objective mentioned above, ranking the replication sessions in descending order is required to determine the adjustment sequence of the replication sessions, and during this process, the remaining replication duration and the new replication bandwidth after the recovery point objective is reduced again are also required to determine whether the final recovery point objective reduction operation is to be performed on the replication session.

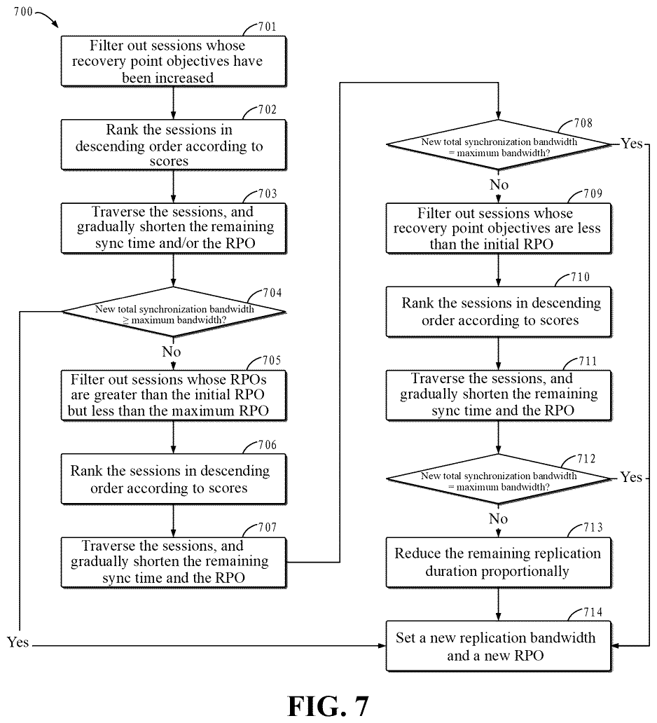

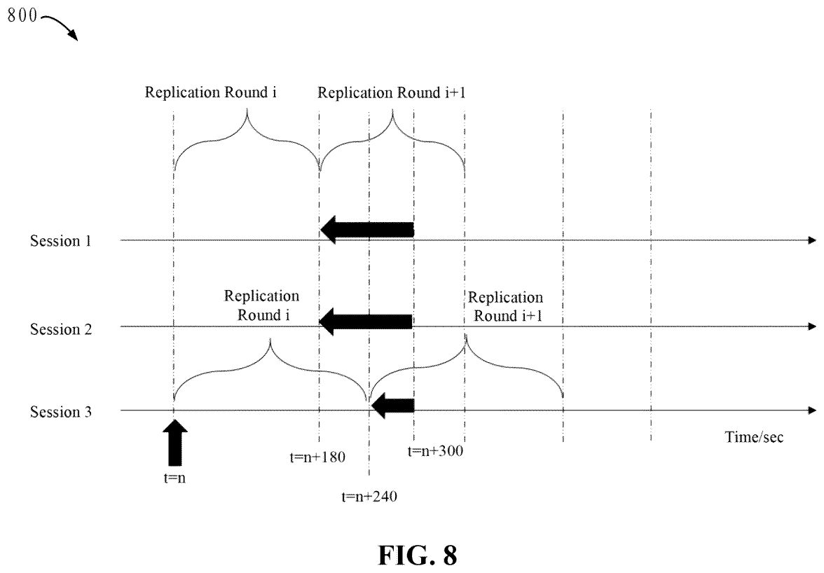

In some embodiments, if the recovery point objectives of all replication sessions have been reduced to the minimum recovery point objective finally, but the total replication bandwidth is still not equal to the replication link bandwidth, the remaining replication durations of the replication sessions will be reduced proportionately. The description will be made below with reference to FIGS. 7-8. FIG. 7 illustrates a schematic diagram of a process 700 of reducing a recovery point objective according to some embodiments of the present disclosure.

Referring to FIG. 7, at 701, the replication sessions whose recovery point objectives have been increased can be filtered out first, and an attempt can be made to adjust the replication sessions. In some embodiments, the replication sessions whose recovery point objectives are the maximum recovery point objective and whose remaining replication duration is greater than the sum of the remaining replication duration and the consumed replication duration may be filtered out first, the replication sessions are traversed at 703, and an attempt can be made to reduce the remaining replication durations of the replication sessions. It can be understood that, in this process, the replication sessions are adjusted one by one in the descending ranking order at 702. In conjunction with Tables 7-9, for session 1, session 2, and session 3, the recovery point objectives are not increased, and the remaining replication durations are also greater than 300 seconds.

Still referring to FIG. 7, after the remaining sync times of the replication sessions are reduced, it is also necessary to calculate a new total replication bandwidth and to determine whether the new total replication bandwidth has been greater than the replication link bandwidth at 704, and if the determination at 704 is yes, the adjustment to the replication sessions may be stopped, and new replication bandwidths and new recovery point objectives are reset for the replication sessions at 714.

If the determination at 704 is no, the replication sessions whose recovery point objectives are greater than the initial recovery point objective and less than the maximum recovery point objective may be filtered out at 705, and ranked again at 706 in descending order according to a comprehensive score. Subsequently, each replication session may be traversed at 707 to gradually reduce the remaining sync time and the recovery point objective. In conjunction with Tables 6-9, the recovery point objectives of session 1, session 2, and session 3 do not satisfy the condition of being greater than the initial recovery point objective.

If, during this process, their recovery point objectives have been reduced to the initial recovery point but the new total replication bandwidth can be equal to the replication link bandwidth, it is determined whether the new total sync bandwidth is equal to the maximum link bandwidth at 708, and if the determination at 708 is yes, then it may be exit from the further adjustment to the replication sessions, and new replication bandwidths and new recovery point objectives may be reset for the replication sessions at 714.

If the determination at 708 is no, then the replication sessions whose recovery point objectives are less than or equal to the initial recovery point objective may be filtered out at 709; similarly at 710, the replication sessions are ranked in descending order based on the scores; then the replication sessions are traversed at 711 to gradually shorten the remaining sync times and the recovery point objectives of the replication sessions; and at the same time, it is determined at 712 whether the new sync bandwidths of the replication sessions can be equal to the maximum bandwidth. In conjunction with Tables 6-9, the descending ranks of session 1, session 2, and session 3 can be calculated based on Formulas (1)-(3), as shown in Table 10:

TABLE 10

| | First | Second | Third | Comprehensive | Descending |
|---|---|---|---|---|---|
| | score | score | score | score | rank |
| Session 1 | 1.7 | 1 | 2 | 3.4 | 1 |
| Session 2 | 1 | 1 | 3 | 3 | 2 |
| Session 3 | 2.1 | 1 | 1 | 2.1 | 3 |

In conjunction with Tables 6-10, a process for adjusting and determining session 1, session 2, and session 3 is shown in Table 11:

TABLE 11

| | | First-Round Adjustment | | | Second-Round Adjustment | |
|---|---|---|---|---|---|---|
| | | First | Second | Third | Fourth | Fifth |
| Session | Sort | Adjustment | adjustment | Adjustment | Adjustment | Adjustment |
| Session 1 | 1 | Remaining | — | — | Remaining | |
| | | replication | | | replication | |
| | | duration −1 | | | duration −1 | |
| | | minute | | | minute | |
| Session 2 | 2 | — | Remaining | — | | Remaining |
| | | | replication | | | replication |
| | | | duration −1 | | | duration −1 |
| | | | minute | | | minute |
| Session 3 | 3 | — | — | Remaining | | |
| | | | | replication | | |
| | | | | duration −1 | | |
| | | | | minute | | |
| Total | / | 1800/240 + 9 + | 1800/240 + 2700/ | 1800/240 + 2700/240 + | 1800/180 + 2700/240 + | 1800/180 + 2700/180 + |
| Replication | | 4 = 20.5 < 30 | 240 + 4 = 22.75 < 30 | 1200/240 = 23.7 < 30 | 1200/240 = 26.25 | 1200/240 == 30 |
| Bandwidth | | | | | | |

The new remaining sync time, new RPO, and new replication bandwidth of each adjusted replication session at the beginning of the replication round are shown in Table 12:

TABLE 12

| | Remaining | New | | |
|---|---|---|---|---|
| | replication | remaining | New | New Replication |
| Session | data/MB | sync time/sec | RPO/min | Bandwidth/(MB/s) |
| Session 1 | 1800 | 180 | 3 | 10 |
| Session 2 | 2700 | 180 | 3 | 15 |
| Session 3 | 1200 | 240 | 4 | 5 |

In some embodiments, a formula for adjusting the new recovery point objective is as follows:

$${New\_RPO}_{ij} = {RPO}_{ij} - RPO\_Increment \qquad ( 12 )$$

where RPOᵢⱼ is the recovery point objective of a replication session at a time point j, and New_RPOᵢⱼ is the new recovery point objective of a replication session at the time point j.

If the determination at 712 is yes, it may exit from the adjustment to the replication sessions so that new replication bandwidths and new RPOs may be set for the replication sessions at 714. In conjunction with FIG. 8, FIG. 8 illustrates a schematic diagram of a replication cycle 800 in which recovery point objectives of some replication sessions are reduced according to some embodiments of the present disclosure. Referring to FIG. 8, the RPOs of session 1 and session 2 will be reduced to 180 seconds, and the 3 sessions will have higher replication bandwidths to complete the replication of data. For session 1 and session 2, replication in the next cycle will begin at the time point t=n+180, and for session 3, replication in the next cycle will begin at the time point t=n+240.

Through the method for dynamically adjusting the recovery point objective, the replication link bandwidth can be utilized most efficiently, thereby improving the replication efficiency.

It can be understood that in the above process of reducing the recovery point objective, the new remaining replication duration can be calculated according to Formula (13):

$$New\_Left \_Sync {\_Time}_{ij} = \{ \begin{matrix}Left\_Sync {\_Time}_{ij} - \\ RPO\_Increment ifLeft \_Sync {\_Time}_{i} > RPO\_Increment \\ Left\_Sync {\_Time}_{ij} if Left\_Sync {\_Time}_{ij} \leq RPO\_Increment\end{matrix} \qquad ( 13 )$$

where Left_Sync_Timeᵢⱼ is the remaining replication duration of a replication session at a time point j, and New_Left_Sync_Timeᵢⱼ is the new remaining replication duration of a replication session at the time point j. If the remaining replication duration of the current replication session is greater than the recovery point objective increment, the new remaining replication duration of the replication session may be determined as the remaining replication duration minus the unit increment. Conversely, if the remaining replication duration of the current replication session is less than or equal to the unit increment, the new remaining replication duration of the replication session can be determined as an original remaining replication duration. In some embodiments, the values of the increments may be set by a user himself.

If the determination at 712 is no, the remaining replication durations of the replication sessions may be reduced proportionally at 713 without adjusting the recovery point objectives of the replication sessions. In some embodiments, the remaining replication durations of the replication sessions are proportionally adjusted as follows:

$$New\_Left \_Sync {\_Time}_{ij} = Left\_Sync {\_Time}_{ij} * \frac{Replication\_Link \_BW}{Total\_Replication {\_BW}_{j}} \qquad ( 14 )$$

where Total_Replication_BWⱼ is the total replication bandwidth at the time point j, Left_Sync_Timeᵢⱼ is the remaining replication duration of a replication session at the time point j, and New_Left_Sync_Timeᵢⱼ is the new remaining replication duration of a replication session at the time point j.

Returning to FIG. 3, after new replication sessions of some sessions are calculated and recovery point objectives of some sessions are reduced at 370 and new replication bandwidths and new recovery points are set for the replication sessions at 380, it is possible to continue to wait at 390 for the next round of state check. Thus, the states of all replication sessions can be obtained for the next round of adjustment.

In some embodiments, the beneficial effects of some embodiments of the present disclosure may also be illustrated according to defined metrics:

For example, a percentage of reduced missing recovery point objectives can be defined to measure the beneficial effects of some embodiments of the present disclosure:

$$\frac{fixed\_missing \_rpo - adaptive\_missing \_rpo}{fixed\_missing \_rpo} \qquad ( 15 )$$

where adaptive_missing_rpo is a missing recovery point objective in some embodiments of the present disclosure, and fixed_missing_rpo is a missing recovery point objective under a fixed recovery point objective algorithm. The percentage of the reduced missing recovery point objectives represents a percentage of reduced missing recovery point objective windows between the fixed recovery point objective algorithm and that in some embodiments of the present disclosure. The higher the value is, the fewer the missing recovery point objective windows are.

For example, a percentage of a reduced cumulated host IO may be defined to measure the beneficial effects of some embodiments of the present disclosure:

$$\frac{fixed\_cumulated \_host10 - adaptive\_cumulated \_hostIO}{fixed\_cumulated \_hostIO} \qquad ( 16 )$$

where fixed_cumulated_hostIO is the cumulated host IO under a fixed recovery point objective algorithm, and adaptive_cumulated_hostIO is the cumulated host IO in some embodiments of the present disclosure. The percentage of the reduced cumulated host IO represents a percentage of a reduced cumulated front-end host IO between a fixed recovery point objective and that in some embodiments of the present disclosure. The higher the value is, the less the cumulated host IO that needs to be tracked and replicated in the next recovery point objective window is.

For example, a percentage of increased synced data may be defined to measure the beneficial effects of some embodiments of the present disclosure:

$$\frac{adaptive\_synced \_data - fixed\_synched \_data}{fixed\_synched \_data} \qquad ( 17 )$$

where fixed_synced_data is the amount of synced data under the fixed recovery point objective algorithm, and adaptive_synced_data is the amount of synced data in some embodiments of the present disclosure. The percentage of the increased synced data represents a percentage of increased amount of synced data between a fixed recovery point objective and that in some embodiments of the present disclosure. The higher the value is, the greater the amount of synced data is.

For example, a percentage of the increased sync BW (bandwidth) usage may be defined to measure the beneficial effects of some embodiments of the present disclosure:

$$\frac{adaptive\_sync \_bw \_usage - fixed\_sync \_bw \_usage}{fixed\_sync \_bw \_usage} \qquad ( 18 )$$

where fixed_sync_bw_usage is the replication bandwidth usage under the fixed recovery point objective algorithm, and adaptive_sync_bw_usage is the replication bandwidth usage in some embodiments of the present disclosure. The percentage of the increased sync bandwidth usage represents a percentage of the increased replication bandwidth usage between a fixed recovery point objective and that in some embodiments of the present disclosure. The higher the value is, the higher the replication bandwidth usage is.

For example, a percentage of increased sync rounds may be defined to measure the beneficial effects of some embodiments of the present disclosure:

$$\frac{adaptive\_sync \_rounds - fixed\_sync \_rounds}{fixed\_sync \_rounds} \qquad ( 19 )$$

where fixed_sync_rounds is the sync rounds under the fixed recovery point objective algorithm, and adaptive_sync_rounds is the sync rounds in some embodiments of the present disclosure. The percentage of the increased sync rounds represents a percentage of the increased sync rounds between a fixed recovery point objective and that in some embodiments of the present disclosure. The higher the value is, the more the completed replication sync rounds are.

For another example, a RPO change count of each session may also be defined to measure the beneficial effects of some embodiments of the present disclosure:

$$\frac{total\_adaptive \_rpo \_change \_count}{total\_session \_count} \qquad ( 20 )$$

where total_session_count is a total count of the replication sessions in some embodiments of the present disclosure, and total_adaptive_rpo_change_count is a RPO change count of the replication sessions in some embodiments of the present disclosure. The RPO change count of each replication session represents the number of changes in the recovery point objective policy of each replication session in some embodiments of the present disclosure. This is a trade-off, since in some embodiments of the present disclosure, there will be minor adjustments to the replication protection policy, while the fixed recovery point objective remains unchanged.

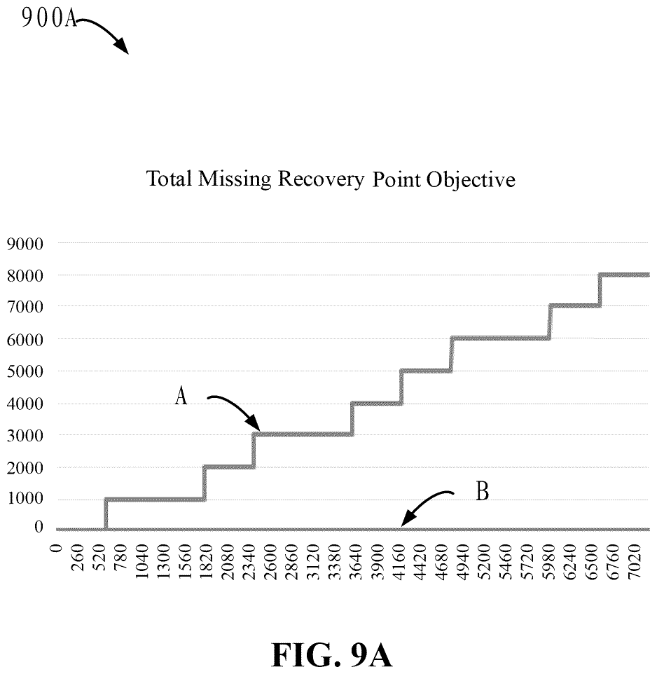

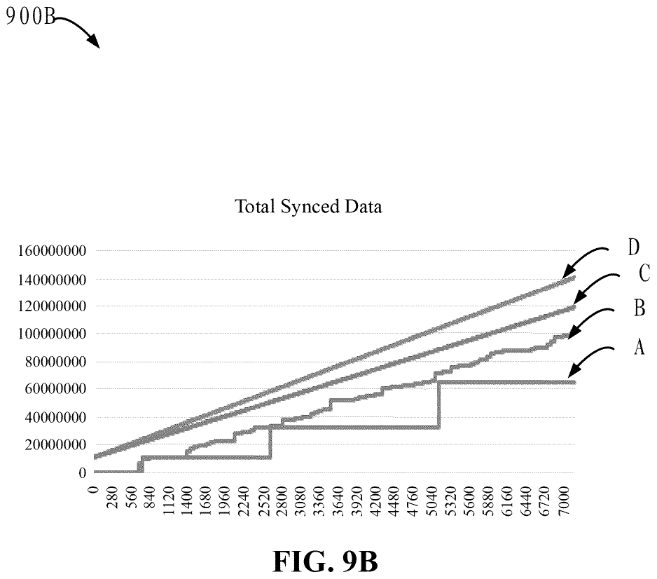

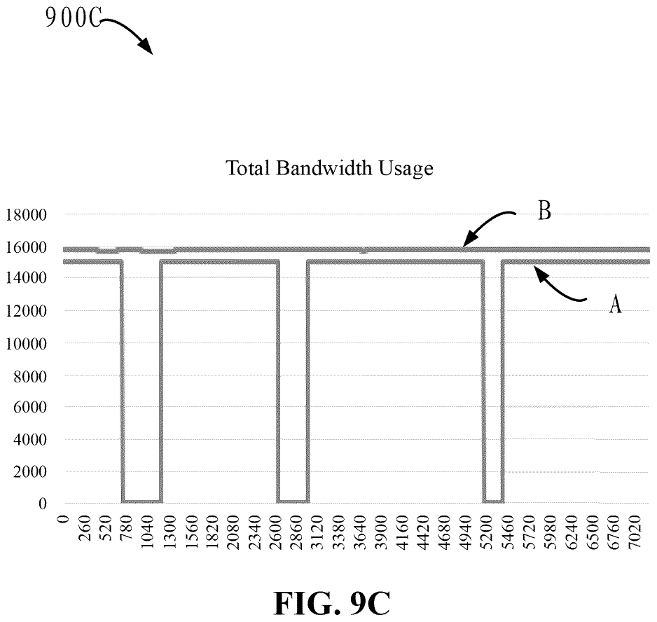

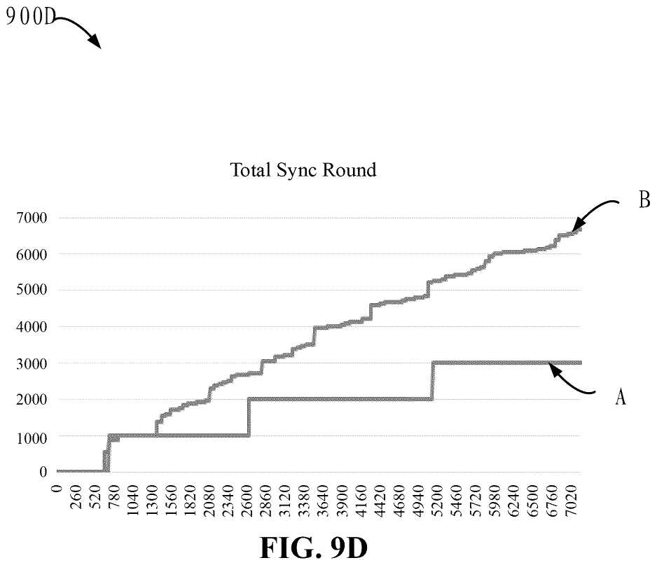

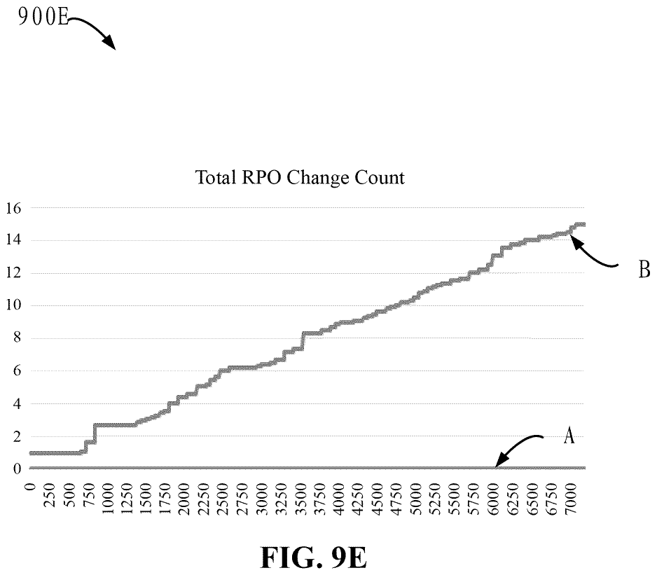

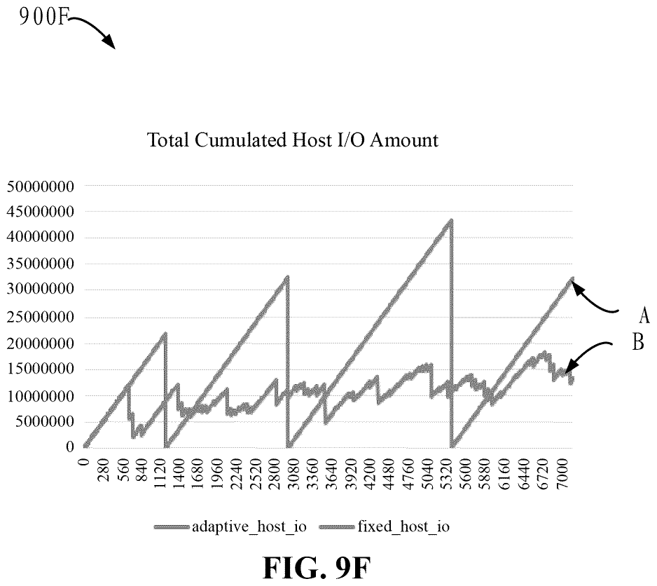

In order to verify the beneficial effects of some embodiments of the present disclosure in dynamically adjusting the recovery point objective, the following simulation experiment is designed: it is assumed that there are 1000 replication sessions, an initial recovery point objective of the replication sessions is 10 minutes, a unit recovery point objective for each adjustment is 1 minute, and a user-defined recovery point objective range is 1-30 minutes. An experimental period is 120 minutes, the initial recovery point objective of each replication session is 10 minutes within 120 minutes of the experimental period, and a total bandwidth allocated within 120 minutes can be greater than, less than, or equal to a replication link bandwidth. The simulation effects of some embodiments of the present disclosure are illustrated below in conjunction with FIGS. 9A-11F.

FIG. 9A illustrates a schematic diagram of the performance 900A of a fixed recovery point objective algorithm and some embodiments of the present disclosure in terms of total missing recovery point objectives in the case where the total replication bandwidth is greater than the replication link bandwidth. As shown in FIG. 9A, there is no missing recovery point objective over the entire timeline in some embodiments of the present disclosure (line B), while there are many missing recovery point objectives in fixed recovery point objectives (line A). The fewer the missing recovery point objectives are, the less pressure the system has to deal with missing recovery point objective events, and the less the time window for data loss is.

FIG. 9B illustrates a schematic diagram of the performance 900B of the fixed recovery point objective algorithm and some embodiments of the present disclosure in terms of total synced data in the case where the total replication bandwidth is greater than the replication link bandwidth. As shown in 9B, by analyzing a chart of the total synced data, the required bandwidths of all sessions (D-line) are greater than the replication link bandwidth (C-line). The total amount of synced data in some embodiments of the present disclosure (line B) is always greater than the total amount of synced data of the fixed recovery point objective (line A) algorithm and is closer to the link bandwidth. The more the synced data is, the less data will be lost in the event of a disaster.

FIG. 9C illustrates a schematic diagram of the performance 900C of the fixed recovery point objective algorithm and some embodiments of the present disclosure in terms of total bandwidth usage in the case where the total replication bandwidth is greater than the replication link bandwidth. As shown in FIG. 9C, the total bandwidth usage measures the replication link bandwidth used by the replication sessions. A bandwidth used in some embodiments of the present disclosure (line B) is almost equal to the replication link bandwidth, while the bandwidth used by the fixed recovery point objective (line A) has some fluctuations and sometimes even drops to zero. As a result, the closer to the link bandwidth, the higher the bandwidth usage is.

FIG. 9D illustrates a schematic diagram of the performance 900D of the fixed recovery point objective algorithm and some embodiments of the present disclosure in terms of total sync rounds in the case where the total replication bandwidth is greater than the replication link bandwidth. As shown in FIG. 9D, in this chart of total sync rounds, the sync rounds in some embodiments of the present disclosure (line B) are always higher than that of the fixed recovery point objective (line A) algorithm. The more the sync rounds are, the more consistent the data is, and the more consistent the data recovery in the event of a disaster is.

FIG. 9E illustrates a schematic diagram of the performance 900E of a fixed recovery point objective algorithm and some embodiments of the present disclosure in terms of a total recovery point objective change count in the case where the total replication bandwidth is greater than the replication link bandwidth. As shown in FIG. 9E, this chart shows the number of changes in the replication protection policy in some embodiments of the present disclosure (line B) over the entire timeline relative to that of the fixed recovery point objective (line A).

FIG. 9F illustrates a schematic diagram of the performance 900F of the fixed recovery point objective algorithm and some embodiments of the present disclosure in terms of total cumulated host I/O amount in the case where the total replication bandwidth is greater than the replication link bandwidth. As shown in FIG. 9F, by analyzing the total cumulated front-end host IO chart at a source site, the total cumulated host IO data in some embodiments of the present disclosure (line B) is smoother than that of the fixed recovery point objective (line A) algorithm and has a lower average over the entire timeline. A smoother and lower curve means that the system uses lower resources and does not fluctuate significantly while tracking and replicating cumulated host IOs in preparation for the next recovery point objective window.

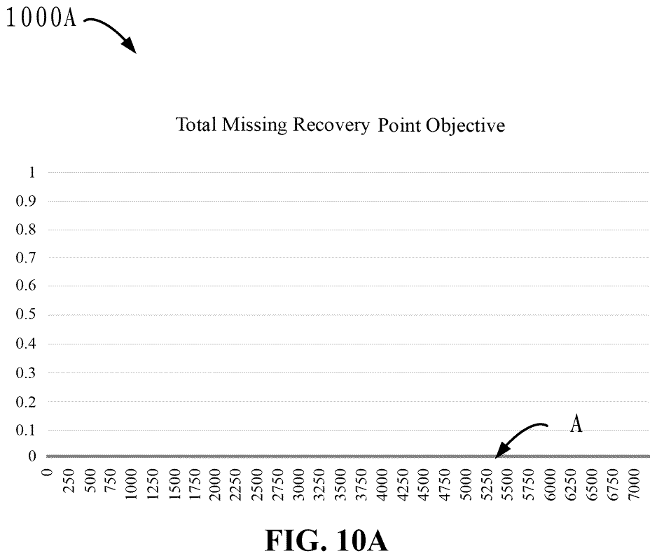

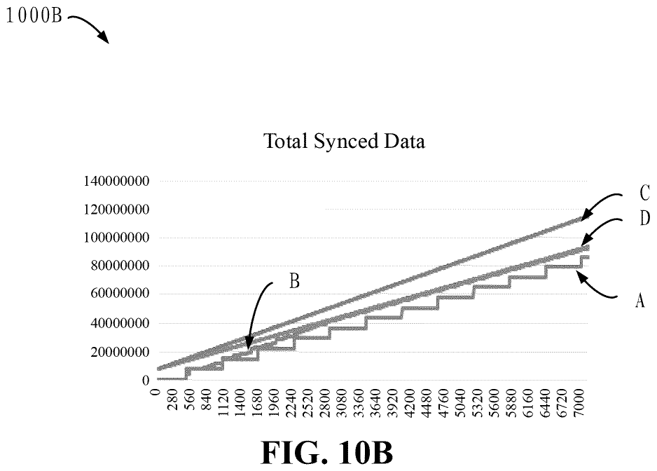

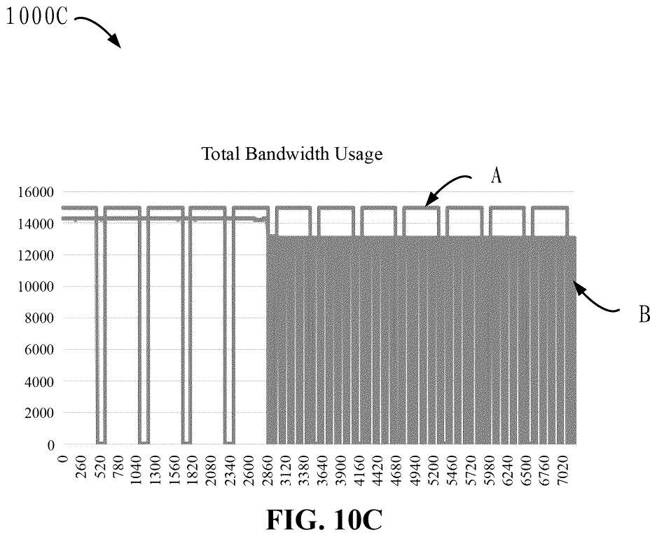

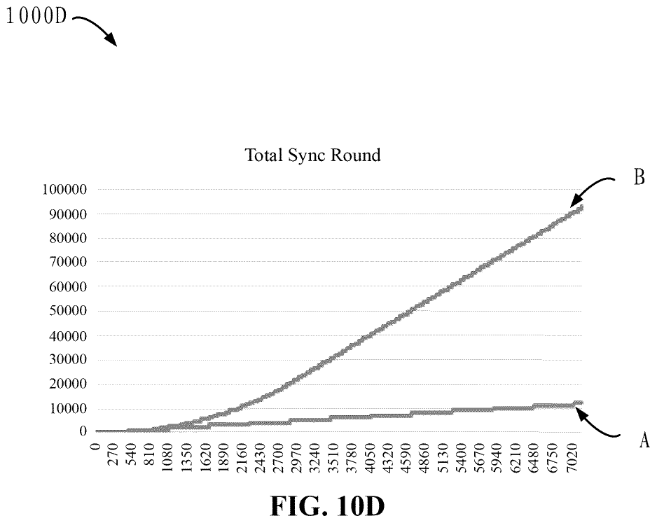

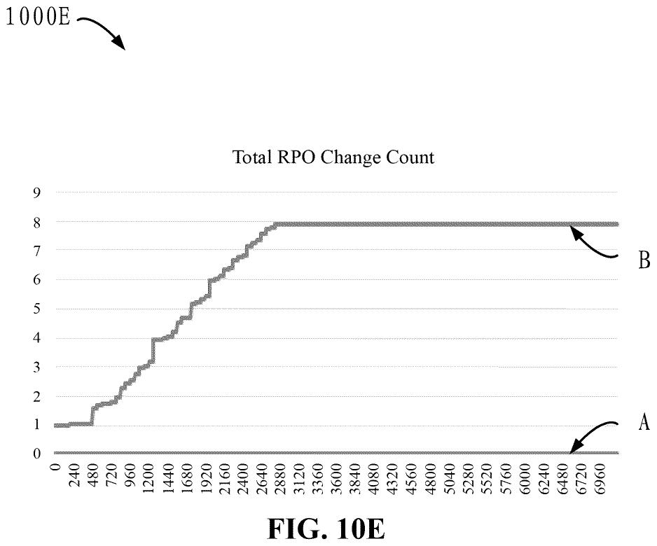

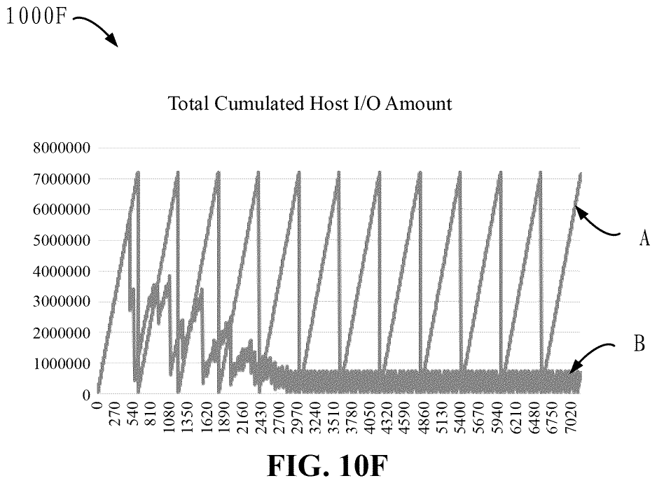

FIGS. 10A-10F illustrate schematic diagrams of example effects where the total replication bandwidth is less than the replication link bandwidth according to some embodiments of the present disclosure. FIG. 10A illustrates a schematic diagram of the performance 1000A of a fixed recovery point objective algorithm and some embodiments of the present disclosure in terms of total missing recovery point objectives in the case where the total replication bandwidth is greater than the replication link bandwidth. As shown in FIG. 10A, there is no missing recovery point objective in some embodiments of the present disclosure (line B) as the fixed recovery point objectives (line A) over the entire timeline. In this scenario, their performance is consistent without any performance degradation.

FIG. 10B illustrates a schematic diagram of the performance 1000B of the fixed recovery point objective algorithm and some embodiments of the present disclosure in terms of total synced data in the case where the total replication bandwidth is less than the replication link bandwidth. As shown in FIG. 10B, by analyzing the chart of the total synced data, we simulate a situation where the allocated bandwidths of all sessions (D-line) are less than the replication link bandwidth (C-line). The total amount of synced data in some embodiments of the present disclosure (line B) is always greater than the total amount of synced data of the fixed recovery point objective (line A) algorithm, is almost equal to the allocated bandwidth, and is closer to the link bandwidth. The more the synced data is, the less data will be lost in the event of a disaster.

FIG. 10C illustrates a schematic diagram of the performance 1000C of the fixed recovery point objective algorithm and some embodiments of the present disclosure in terms of total bandwidth usage in the case where the total replication bandwidth is less than the replication link bandwidth. As shown in FIG. 10C, the total bandwidth usage measures the replication link bandwidth used by the replication sessions. A bandwidth used in some embodiments of the present disclosure (line B) is almost equal to the replication link bandwidth, while the bandwidth used by the fixed recovery point objective (line A) has some fluctuations and sometimes even drops to zero. As a result, the closer to the link bandwidth, the higher the bandwidth usage is.

FIG. 10D illustrates a schematic diagram of the performance 1000D of the fixed recovery point objective algorithm and some embodiments of the present disclosure in terms of total sync rounds in the case where the total replication bandwidth is less than the replication link bandwidth. As shown in FIG. 10D, in this chart of total sync rounds, the sync rounds in some embodiments of the present disclosure (line B) are always higher than that of the fixed recovery point objective (line A) algorithm. The more the sync rounds are, the more consistent the data is, and the more consistent the data recovery in the event of a disaster is.

FIG. 10E illustrates a schematic diagram of the performance 1000E of a fixed recovery point objective algorithm and some embodiments of the present disclosure in terms of a total recovery point objective change count in the case where the total replication bandwidth is less than the replication link bandwidth. As shown in FIG. 10E, this chart shows the number of changes in the replication protection policy in some embodiments of the present disclosure (line B) over the entire timeline relative to that of the fixed recovery point objective (line A). This is a trade-off, and we need to make some minor policy adjustments to accommodate the dynamic algorithm.

FIG. 10F illustrates a schematic diagram of the performance 1000F of the fixed recovery point objective algorithm and some embodiments of the present disclosure in terms of total cumulated host I/O amount in the case where the total replication bandwidth is less than the replication link bandwidth. As shown in FIG. 10F, by analyzing the total cumulated front-end host IO chart at a source site, the total cumulated host IO data in some embodiments of the present disclosure (line B) is smoother than that of the fixed recovery point objective (line A) algorithm and has a lower average over the entire timeline. A smoother and lower curve means that the system uses lower resources and does not fluctuate significantly while tracking and replicating cumulated host IOs in preparation for the next recovery point objective window.

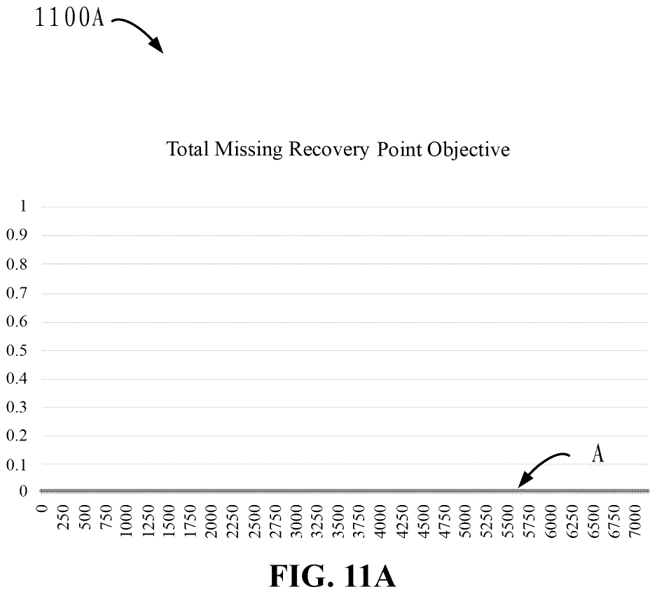

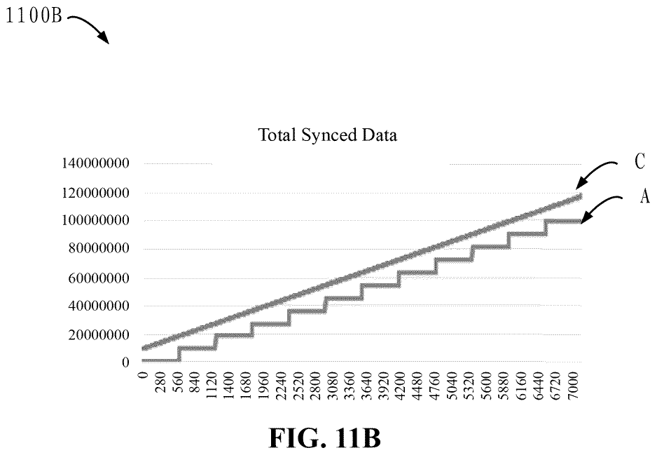

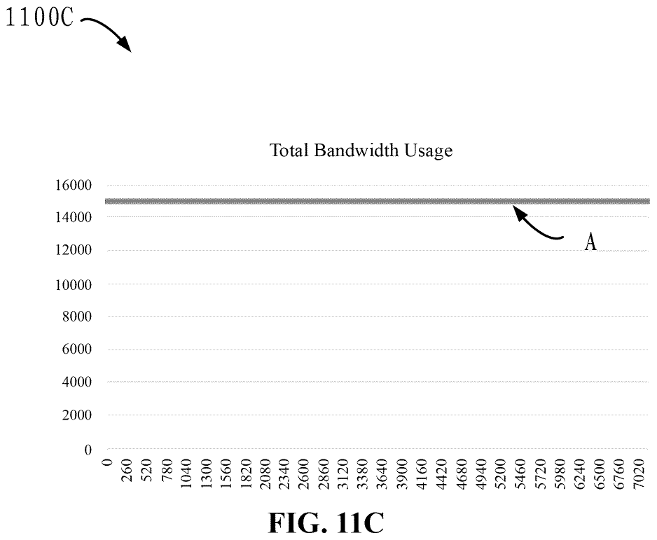

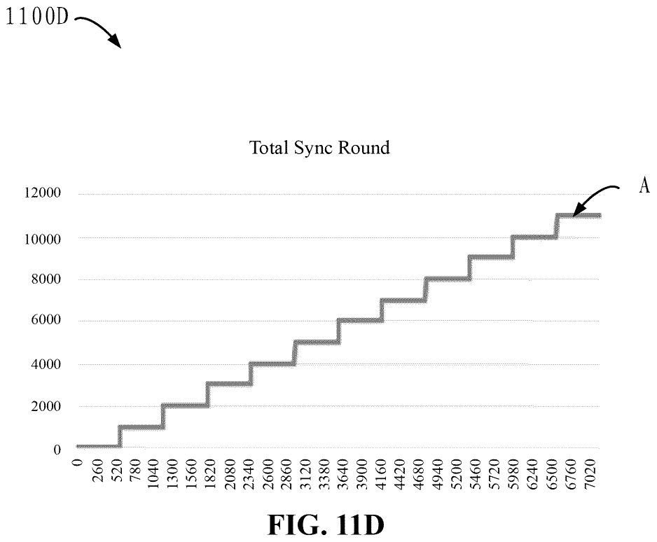

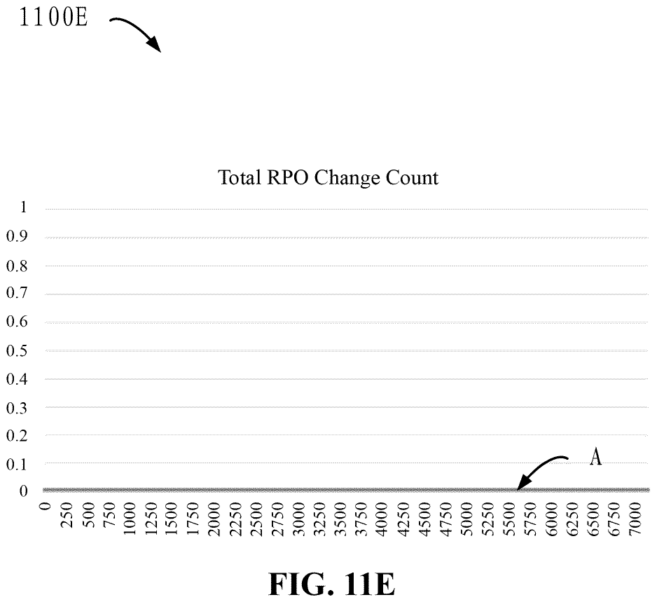

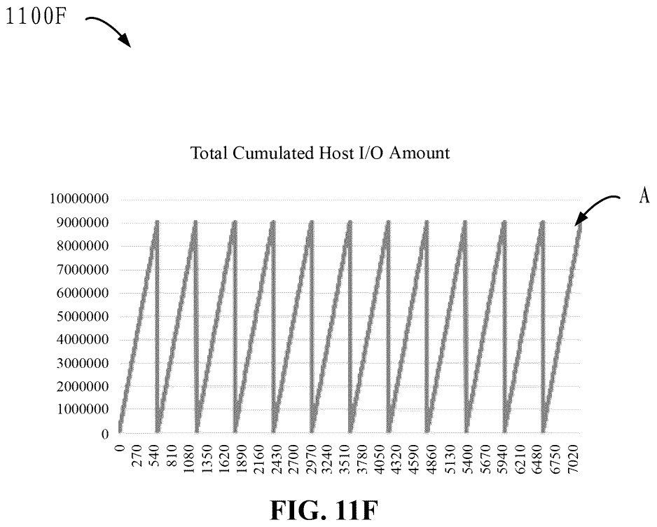

FIGS. 11A-11F illustrate schematic diagrams of performances 1100A, 1100B, 1100C, 1100D, 1100E, and 1100F of the fixed recovery point objective algorithm and some embodiments of the present disclosure in the terms of total missing recovery point objectives, total synced data, total bandwidth usage, total sync rounds, total RPO change count, and total cumulated host I/O amount in the case where the total replication bandwidth is greater than the replication link bandwidth. As shown in FIGS. 11A-11F, some embodiments of the present disclosure (line B) are identical to the fixed recovery point objective (line A) in terms of various metrics over the entire timeline. In this scenario, their performance is consistent without any performance degradation.

In some embodiments, the data in Table 13 may be obtained based on the simulation experiment data, FIG. 9A-FIG. 11F, and the defined evaluation criteria:

TABLE 13

| | | Reduced | | | | |
|---|---|---|---|---|---|---|
| | Percentage | total | | | | |
| | of reduced | cumulated | | Percentage | | |
| | missing | host I/O | Percentage | of increased | Percentage | |
| | recovery | amount | of increased | total sync | of increased | RPO |
| | point | within RPO | data | bandwidth | total sync | change |
| | objectives | window | synced | usage | rounds | count |
| The total | 100% | 40.93% | 43.33% | 23.16% | 122.07% | 14.95 |
| replication | | | | | | |
| bandwidth is | | | | | | |
| greater than the | | | | | | |
| replication link | | | | | | |
| bandwidth | | | | | | |
| The total | 0 | 73.43% | 7.5% | 123.83% | 671.66% | 7.89 |
| replication | | | | | | |
| bandwidth is less | | | | | | |
| than the | | | | | | |
| replication link | | | | | | |
| bandwidth | | | | | | |
| The total | 0 | 0 | 0 | 0 | 0 | 0 |
| replication | | | | | | |
| bandwidth is | | | | | | |
| equal to the | | | | | | |
| replication link | | | | | | |
| bandwidth | | | | | | |

Based on Table 13, it can be analyzed that some embodiments of the present disclosure have improved by 100.00% in reducing the number of missing recovery point objective events. Some embodiments of the present disclosure have improved by 73.43% in reducing the cumulated host IO in the RPO window. Some embodiments of the present disclosure have improved by 43.33% in increasing the amount of synced data. Some embodiments of the present disclosure have improved by 123.83% in increasing the sync bandwidth usage. Some embodiments of the present disclosure have improved by 671.66% in increasing the sync rounds. In some embodiments of the present disclosure, the number of changes in the replication protection policy is 0.

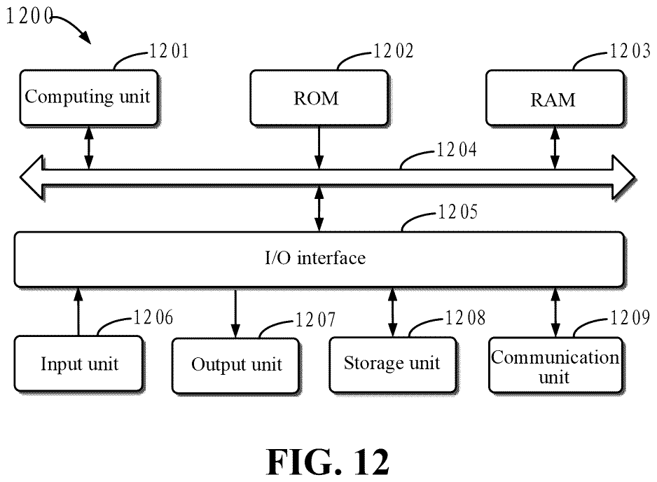

FIG. 12 shows a schematic block diagram of an example device 1200 that can be used to implement an embodiment of the present disclosure. As shown in the figure, the device 1200 includes a computing unit 1201 that may perform various appropriate actions and processing according to computer program instructions stored in a read-only memory (ROM) 1202 or computer program instructions loaded from a storage unit 1208 to a random access memory (RAM) 1203. Various programs and data required for the operation of the device 1200 may also be stored in the RAM 1203. The computing unit 1201, the ROM 1202, and the RAM 1203 are connected to each other through a bus 1204. An input/output (I/O) interface 1205 is also connected to the bus 1204.

A plurality of components in the device 1200 are connected to an I/O interface 1205, including: an input unit 1206 such as a keyboard and a mouse; an output unit 1207, such as various types of displays and speakers; the storage unit 1208, such as a magnetic disk and an optical disc; and a communication unit 1209, such as a network card, a modem, and a wireless communication transceiver. The communication unit 1209 allows the device 1200 to exchange information/data with other devices via a computer network, such as the Internet, and/or various telecommunication networks.

The computing unit 1201 may be various general-purpose and/or special-purpose processing components with processing and computing capabilities. Some examples of the computing unit 1201 include, but are not limited to, a central processing unit (CPU), a graphics processing unit (GPU), various specialized artificial intelligence (AI) computing chips, various computing units for running machine learning model algorithms, a digital signal processor (DSP), and any appropriate processor, controller, microcontroller, and the like. The computing unit 1201 performs various methods and processing described above, such as the method 200. For example, in some embodiments, the method 200 may be implemented as a computer software program that is tangibly included in a machine-readable medium, such as the storage unit 1208. In some embodiments, some or all of the computer program may be loaded and/or installed onto the device 1200 via the ROM 1202 and/or the communication unit 1209. When the computer program is loaded to the RAM 1203 and executed by the computing unit 1201, one or more steps of the method 200 described above may be performed. Alternatively, in other embodiments, the computing unit 1201 may be configured to implement the method 200 in any other suitable manners (such as by means of firmware).

The functions described herein above may be executed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Parts (ASSPs), Systems On Chip (SOC), Complex Programmable Logic Devices (CPLDs), etc.

Program code for implementing the method of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, causes the functions/operations specified in the flow charts and/or block diagrams to be implemented. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for adjusting a recovery point objective, comprising:
determining a total replication bandwidth and a replication link bandwidth, wherein the total replication bandwidth indicates the sum of replication bandwidths of a plurality of replication sessions, and the replication link bandwidth indicates a maximum bandwidth of a replication link;
increasing a recovery point objective of the replication link in response to the total replication bandwidth being greater than the replication link bandwidth, wherein the recovery point objective indicates a maximum data loss time range; and
reducing the recovery point objective of the replication link in response to the total replication bandwidth being less than the replication link bandwidth.

2. The method according to claim 1, further comprising:
determining the ranks of the plurality of replication sessions based on a comprehensive score of the replication sessions.

3. The method according to claim 2, wherein determining the ranks of the plurality of replication sessions based on the comprehensive score of the replication sessions comprises:
determining a first score for each replication session based on a remaining replication amount of each replication session; and
determining a second score for each replication session based on a user-defined priority for a current replication task; and
determining a third score for each replication session based on a total host input/output (I/O) amount of each replication session; and
determining the ranks of the plurality of replication sessions based on the first scores, the second scores, and the third scores.

4. The method according to claim 3, wherein determining the ranks of the plurality of replication sessions based on the first scores, the second scores, and the third scores comprises:
ranking the plurality of replication sessions in ascending order in response to the total replication bandwidth being greater than the replication link bandwidth;
alternatively ranking the plurality of replication sessions in descending order in response to the total replication bandwidth being less than the replication link bandwidth.

5. The method according to claim 1, wherein increasing the recovery point objective of the replication link in response to the total replication bandwidth being greater than the replication link bandwidth comprises:
determining in order, from the plurality of replication sessions ranked in ascending order, a replication session whose recovery point objective is less than an initial recovery point objective; and
increasing the recovery point objective of the replication session whose recovery point objective is less than the initial recovery point objective to the initial recovery point objective.

6. The method according to claim 5, further comprising:
in response to detecting that the total replication bandwidth is still greater than the replication link bandwidth after the recovery point objective of the replication session whose recovery point objective is less than the initial recovery point objective is increased, determining a replication session whose recovery point objective is greater than the initial recovery point objective from the plurality of replication sessions; and
increasing the recovery point objective of the replication session whose recovery point objective is greater than the initial recovery point objective to a maximum recovery point objective.

7. The method according to claim 6, in the process of increasing the recovery point objective of the replication link, further comprising:
in response to a remaining replication duration of each replication session whose recovery point objective is increased being greater than a half of a predetermined unit recovery point objective increment, determining that a new remaining replication duration of each replication session whose recovery point objective is increased is the sum of the new remaining replication duration of each replication session whose recovery point objective is increased and the predetermined unit recovery point objective increment; alternatively
in response to a remaining replication duration of each replication session whose recovery point objective is increased being less than or equal to a half of the predetermined unit recovery point objective increment, determining that the new remaining replication duration of each replication session whose recovery point objective is increased is an original remaining replication duration of each replication session whose recovery point objective is increased.

8. The method according to claim 7, further comprising:
based on the amount of remaining replication data of each replication session whose recovery point objective is increased and the new remaining replication duration of each replication session whose recovery point objective is increased, determining a new replication bandwidth of each replication session whose recovery point objective is increased.

9. The method according to claim 8, further comprising:
determining whether the total replication bandwidth is equal to the replication link bandwidth; and
in response to the total replication bandwidth being less than or equal to the replication link bandwidth, ending the increase in the recovery point objective of the replication link; alternatively
in response to the recovery point objectives of the plurality of replication sessions having been increased to the maximum recovery point objective and the total replication bandwidth still being greater than the replication link bandwidth, increasing the remaining replication durations of the plurality of replication sessions proportionally.

10. The method according to claim 7, wherein increasing the remaining replication durations of the plurality of replication sessions proportionally comprises:
based on the total replication bandwidth, the replication link bandwidth, and the remaining replication duration of each replication session, determining a new remaining replication duration of each replication session whose recovery point objective is increased proportionally.

11. The method according to claim 1, wherein reducing the recovery point objective of the replication link in response to the total replication bandwidth being less than the replication link bandwidth comprises:
determining in order, from the plurality of replication sessions ranked in descending order, a replication session whose recovery point objective is equal to the maximum recovery point objective and whose remaining replication duration in the next round is greater than the sum of the remaining replication duration and the consumed replication duration; and
reducing the remaining replication duration of each replication session whose recovery point objective is equal to the maximum recovery point objective and whose remaining replication duration in the next round is greater than the sum of the remaining replication duration and the consumed replication duration, and keeping the recovery point objective of each replication session unchanged.

12. The method according to claim 11, further comprising:
in response to detecting that the remaining replication duration of each replication session whose remaining replication duration is reduced has been reduced to a difference between the recovery point objective of each replication session and the consumed replication duration of each replication session and detecting that the total replication bandwidth is still less than the replication link bandwidth, determining, from the plurality of replication sessions, a replication session whose recovery point objective is greater than an initial recovery point objective and less than a maximum recovery point objective; and
reducing the remaining replication duration of each replication session whose recovery point objective is greater than the initial recovery point objective and less than the maximum recovery point objective.

13. The method according to claim 12, further comprising:
in response to detecting that the total replication bandwidth is still less than the replication link bandwidth, reducing the remaining replication duration of each replication session whose recovery point objective is less than the initial recovery point objective.

14. The method according to claim 13, in the process of reducing the recovery point objective of the replication link, further comprising:
in response to a remaining replication duration of each replication session whose recovery point objective is reduced being greater than a predetermined unit recovery point objective increment, determining that a new remaining replication duration of each replication session whose recovery point objective is reduced is a difference between the new remaining replication duration of each replication session whose recovery point objective is reduced and the predetermined unit recovery point objective increment; alternatively
in response to the remaining replication duration of each replication session whose recovery point objective is reduced being less than or equal to the predetermined unit recovery point objective increment, determining that the new remaining replication duration of each replication session whose recovery point objective is reduced is an original remaining replication duration of each replication session whose recovery point objective is reduced.

15. The method according to claim 14, further comprising:
based on the amount of remaining replication data of each replication session whose recovery point objective is reduced and the new remaining replication duration of each replication session whose recovery point objective is reduced, determining a new replication bandwidth of each replication session whose recovery point objective is reduced.

16. The method according to claim 15, further comprising:
determining whether the total replication bandwidth is equal to the replication link bandwidth; and
in response to detecting that the recovery point objective of each replication session has been reduced to a minimum recovery point objective and the total replication bandwidth is still less than the replication link bandwidth, reducing the remaining replication durations of the plurality of replication sessions proportionally.

17. The method according to claim 16, wherein reducing the remaining replication durations of the plurality of replication sessions proportionally comprises:
based on the total replication bandwidth, the replication link bandwidth, and the remaining replication duration of each replication session, determining a new remaining replication duration of each replication session whose recovery point objective is reduced proportionally.

18. An electronic device, comprising:
at least one processor; and
coupled to the at least one processor and having instructions stored thereon, the instructions, when executed by the at least one processor, causing the electronic device to perform actions comprising:
determining a total replication bandwidth and a replication link bandwidth, wherein the total replication bandwidth indicates the sum of replication bandwidths of a plurality of replication sessions, and the replication link bandwidth indicates a maximum bandwidth of a replication link;
increasing a recovery point objective of the replication link in response to the total replication bandwidth being greater than the replication link bandwidth, wherein the recovery point objective indicates a maximum data loss time range; and
reducing the recovery point objective of the replication link in response to the total replication bandwidth being less than the replication link bandwidth.

19. The device according to claim 18, further comprising:
determining the ranks of the plurality of replication sessions based on a comprehensive score of the replication sessions.

20. A computer program product having a non-transitory computer readable medium which stores a set of instructions to adjust a recovery point objective; the set of instructions, when carried out by computerized circuitry, causing the computerized circuitry to perform a method of:
determining a total replication bandwidth and a replication link bandwidth, wherein the total replication bandwidth indicates the sum of replication bandwidths of a plurality of replication sessions, and the replication link bandwidth indicates a maximum bandwidth of a replication link;
increasing a recovery point objective of the replication link in response to the total replication bandwidth being greater than the replication link bandwidth, wherein the recovery point objective indicates a maximum data loss time range; and
reducing the recovery point objective of the replication link in response to the total replication bandwidth being less than the replication link bandwidth.
